(19) United States
(12) Patent Application Publication
(10) Pub. No.: US 2024/0112040 A1
(43) Pub. Date: Apr. 4, 2024

(54) FEDERATED LEARNING SYSTEM FOR IMPROVED REPRESENTATION, FEDERATED LEARNING METHOD, AND RECORDING MEDIUM STORING INSTRUCTIONS TO PERFORM FEDERATED LEARNING METHOD

(71) Applicant: Korea Advanced Institute of Science and Technology, Daejeon (KR)

(72) Inventors: Seyoung YUN, Daejeon (KR); Seongyoon KIM, Daejeon (KR); Woojin CHUNG, Daejeon (KR); Sangmin BAE, Daejeon (KR)

(21) Appl. No.: 18/472,393

(22) Filed: Sep. 22, 2023

(30) Foreign Application Priority Data
Sep. 30, 2022 (KR) 10-2022-0125654

(51) Int. Cl. G06N 3/098; G06N 3/09

(52) U.S. Cl. CPC G06N 3/098; G06N 3/09

(57) ABSTRACT

A federated learning system includes: a central server including a central learning model containing an extractor; and client devices each including a local learning model performing federated learning with the central learning model. The local learning model includes an extractor and a classifier, and the central server transmits state information of the extractor in the central learning model to a client device among the client devices, receives state information of the extractor in the local learning model from the client device, and updates the extractor in the central learning model using the received state information, and the client device uploads the state information to the extractor in the local learning model, trains the extractor and the classifier in the local learning model using individual training data, and transmits state information of the extractor trained in the local learning model to the central server.

### CROSS REFERENCE TO RELATED APPLICATION

The present application claims priority to Korean Patent Application No. 10-2022-0125654, filed Sep. 30, 2022, the entire contents of which is incorporated herein for all purposes by this reference.

### TECHNICAL FIELD

The present disclosure relates to a federated learning system for improved representation, a client device configuring the federated learning system, and a federated learning method using the same.

This work was supported by Institute of Information & communications Technology Planning & Evaluation (IITP) grant funded by Korea government (MSIT) (No. 2021-0-00907, Development of Adaptive and Lightweight Edge-Collaborative Analysis Technology for Enabling Proactively Immediate Response and Rapid Learning).

### BACKGROUND OF THE DISCLOSURE

Recently, with the development of cloud and big data technologies, artificial intelligence (AI) technology is being applied to various services. In order to apply such artificial intelligence technology to services, the procedure of learning an artificial intelligence model based on a large amount of data needs to be preceded.

Training of artificial intelligence models requires significant computational resources to perform large-scale computations. As an example, the cloud computing service is a service that provides a cloud computing infrastructure to train an artificial intelligence model without installing complex hardware and software. Since cloud computing is based on the centralization of resources, all necessary data needs to be stored in cloud memory and used for model learning. Data centralization offers many benefits in terms of maximizing efficiency, but there is a risk of leakage of user personal data and significant network costs are incurred as data is transmitted.

Recently, federated learning has been actively studied to overcome these issues. Federated learning is a type of learning method that centrally collects models trained by each client device based on individual data held by multiple client devices, rather than centrally collecting and training user personal data as in the past. Since such federated learning does not collect user personal data centrally, there is little possibility of invasion of privacy, and network costs may be reduced because only state information such as a parameter of an updated model is allowed to be transmitted.

### SUMMARY

According to an embodiment, there is provided a federated learning system that improves the performance of federated learning through representation improvement, a client device configuring the federated learning system, and a federated learning method using the same.

The aspects of the present disclosure are not limited to those mentioned above, and other aspects not mentioned herein will be clearly understood by those skilled in the art from the following description.

In accordance with an aspect of the present disclosure, there is provided a federated learning system, the system may comprise: a central server including a central learning model containing an extractor; and a plurality of client devices each including a local learning model performing federated learning with the central learning model, wherein the local learning model includes an extractor and a classifier. The central server is configured to transmit state information of the extractor in the central learning model to at least one client device among the plurality of client devices, receive state information of the extractor in the local learning model from the at least one client device, and update the extractor in the central learning model using the received state information, and the at least one client device is configured to upload the state information to the extractor in the local learning model, train the extractor and the classifier in the local learning model using individual training data, and transmit state information of the extractor trained in the local learning model to the central server.

The at least one client device may be selected by the server among the plurality of client devices.

The at least one client device may include a supervised learning model having a structure same as that of the local learning model and containing an extractor and a classifier, and the at least one client device may upload the state information to the extractor in the supervised learning model and the extractor in the local learning model, respectively, input the individual training data to the extractor in the supervised learning model and the extractor in the local learning model, and train the extractor and the classifier in the local learning model by a knowledge distillation technique while the supervised learning model is fixed.

The individual training data may include an image data and a label data, and the at least one client device may input the image to the extractor in the supervised learning model and the extractor in the local learning model, and train the extractor and the classifier in the local learning model to predict the label data from the input image data.

The label data may include a probability vector of a correct answer, and the at least one client device may generate the probability vector from an output vector of the supervised learning model and an output vector of the local learning model, and train the extractor and classifier in the local learning model to reduce an objective loss function calculated from the probability vector of the correct answer and the generated probability vector

The probability vector of the correct answer, the output vector of the supervised learning model, and the output vector of the local learning model are C-dimensional. The at least one client device may process a C-dimensional output vector of the supervised learning model and a C-dimensional output vector of the local learning model respectively into a (C-1)-dimensional output vector of the supervised learning model and a (C-1)-dimensional output vector of the local learning model; generate a first (C-1)-dimensional probability vector and a second (C-1)-dimensional probability vector respectively from the respectively processed (C-1)-dimensional output vector of the supervised learning model and the processed (C-1)-dimensional output vector of the local learning model; generate a C-dimensional probability vector from the C-dimensional output vector of the local learning model; calculate a not true distillation (NTD) loss function from a difference between the first (C-1)-dimensional probability vector and the second (C-1)-dimensional probability vector; calculate a cross-entropy loss function from a difference between the generated C-dimensional probability vector and the probability vector of the correct answer; and calculate the objective loss function as a sum of the NTD loss function and the cross-entropy loss function.

In accordance with another aspect of the present disclosure, there is provided a method for a client device including a local learning model to perform federated learning with a central server including a central learning model containing an extractor and other client devices including a local learning model containing an extractor and a classifier, the method may comprise: training the extractor and the classifier in the local learning model using individual training data after state information of the extractor in the central learning model is uploaded to the extractor in the local learning model; and transmitting state information of the extractor trained in the local learning model to the central server so as to update state information of the extractor trained in the local learning model to the extractor in the central learning model.

The client device may include a supervised learning model having a structure same as that of the local learning model and containing an extractor and a classifier. The training the extractor and the classifier in the local learning model may include: uploading the state information to the extractor in the supervised learning model and the extractor in the local learning model, respectively, inputting the individual training data to the extractor in the supervised learning model and the extractor in the local learning model, and training the extractor and the classifier in the local learning model using a knowledge distillation while the supervised learning model is fixed.

The individual training data may include an image data and a label data. The training the extractor and the classifier in the local learning model may include: inputting the image data to the extractor in the supervised learning model and the extractor in the local learning model, and training the extractor and the classifier in the local learning model to predict the label data from the input image data.

The label data may include a probability vector of a correct answer. The training the extractor and the classifier in the local learning model includes: generating the probability vector from an output vector of the supervised learning model and an output vector of the local learning model, and training the extractor and classifier in the local teaming model to reduce an objective loss function calculated from the probability vector of the correct answer and the generated probability vector.

The probability vector of the correct answer, the output vector of the supervised learning model, and the output vector of the local learning model may be C-dimensional.

The training the extractor and the classifier in the local learning model may include: processing a C-dimensional output vector of the supervised learning model and a C-dimensional output vector of the local learning model respectively into a (C-1)-dimensional output vector of the supervised learning model and a (C-1)-dimensional output vector of the local learning model; generating a first (C-1)-dimensional probability vector and a second (C-1)-dimensional probability vector respectively from the processed (C-1)-dimensional output vector of the supervised learning model and the processed (C-1)-dimensional output vector of the local learning model; generating a C-dimensional probability vector from the C-dimensional output vector of the local learning model; calculating a not true distillation (NTD) loss function from a difference between the first (C-1)-dimensional probability vector and the second (C-1)-dimensional probability vector; calculating a cross-entropy loss function from a difference between the generated C-dimensional probability vector and the probability vector of the correct answer; and calculating the objective loss function as a sum of the NTD loss function and the cross-entropy loss function.

In accordance with another aspect of the present disclosure, there is provided a non-transitory computer-readable recording medium storing a computer program, which comprises instructions for a processor to perform a method for a client device including a local learning model containing an extractor and a classifier to perform federated learning with a central server including a central learning model containing an extractor, the method may comprise: training the extractor and the classifier in the local learning model using individual training data after state information of the extractor in the central learning model of the central server is uploaded to the extractor in the local learning model; and transmitting state information of the extractor trained in the local learning model to the central server so as to update state information of the extractor trained in the local learning model to the extractor in the central learning model.

The client device may include a supervised learning model having a structure same as that of the local learning model and containing an extractor and a classifier.

The training the extractor and the classifier in the local learning model may include: uploading the state information to the extractor in the supervised learning model and the extractor in the local leaning model, respectively, inputting the individual training data to the extractor in the supervised learning model and the extractor in the local learning model, and training the extractor and the classifier in the local learning model using a knowledge distillation while the supervised learning model is fixed.

The individual training data may include an image data and a label data. The training the extractor and the classifier in the local learning model may include: inputting the image to the extractor in the supervised learning model and the extractor in the local learning model, and training the extractor and the classifier in the local learning model to predict the label data from the input image data.

The label data may be a probability vector of a correct answer. The training the extractor and the classifier in the local learning model may include: generating the probability vector from an output vector of the supervised learning model and an output vector of the local learning model, and training the extractor and classifier in the local learning model to reduce an objective loss function calculated from the probability vector of the correct answer and the generated probability vector.

The probability vector of the correct answer, the output vector of the supervised learning model, and the output vector of the local leaning model may be C-dimensional. The training the extractor and the classifier in the local learning model includes: processing a C-dimensional output vector of the supervised learning model and a C-dimensional output vector of the local learning model respectively into a (C-1)-dimensional output vector of the supervised learning model and a (C-1)-dimensional output vector of the local learning model; generating a first (C-1)-dimensional probability vector and a second (C-1)-dimensional probability vector respectively from the processed (C-1)-dimensional output vector of the supervised learning model and the processed (C-1)-dimensional output vector of the local learning model; generating a C-dimensional probability vector from the C-dimensional output vector of the local learning model; calculating a not true distillation (NTD) loss function from a difference between the first (C-1)-dimensional probability vector and the second (C-1)-dimensional probability vector; calculating a cross-entropy loss function from a difference between the generated C-dimensional probability vector and the probability vector of the correct answer; and calculating the objective loss function as a sum of the NTD loss function and the cross-entropy loss function.

According to an embodiment, state information of the extractor in the central learning model is transmitted to the client device, the client device uploads the received state information to the extractor in an individual learning model, and then the individual training data is used to perform learning with the extractor and the classifier. Through federated learning that transmits the state information updated through learning to the central server, improvement of the representation is promoted, and finally, the performance of federated learning is improved.

The benefits of the present disclosure are not limited to those mentioned above, and other benefits not mentioned herein will be clearly understood by those skilled in the art from the following description.

### BRIEF DESCRIPTION OF THE DRAWINGS

FIG. 1 is a block diagram illustrating a federated learning system according to an embodiment of the present disclosure.

FIG. 2 is an exemplary diagram illustrating the structure of a federated learning model used in a federated learning system according to an embodiment of the present disclosure.

FIG. 3 is an exemplary diagram illustrating an operation in which a central server transmits state information to each client device and each client device learns individual training data according to an embodiment of the present disclosure.

FIG. 4 is an exemplary diagram illustrating an operation in which each client device transmits updated state information to a central server, and the central server collects the updated state information of each client device and updates an extractor in a federated learning model according to an embodiment of the present disclosure.

FIG. 5 is an exemplary diagram illustrating an operation in which each client device trains a classifier and an extractor in a local learning model using a knowledge distillation technique according to an embodiment of the present disclosure.

FIG. 6 is a flowchart illustrating a signal processing process in which each client device performs a federated learning method according to an embodiment of the present disclosure.

FIG. 7 is an exemplary diagram illustrating an evaluation process for a result of federated learning by a central server and a client device according to an embodiment of the present disclosure.

### DETAILED DESCRIPTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

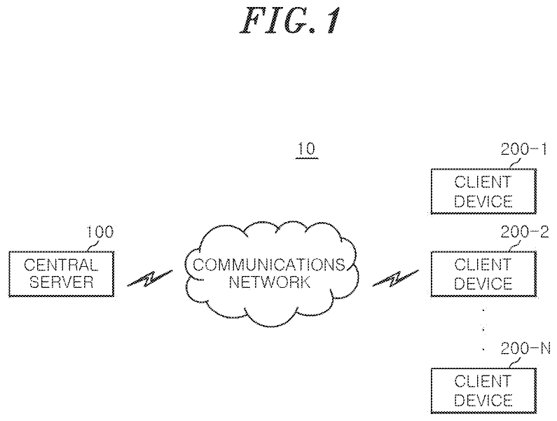

FIG. 1 is a configuration diagram illustrating a federated learning system 10 according to an embodiment of the present disclosure.

Referring to FIG. 1, the federated learning system 10 according to an embodiment may include a central server 100 and a plurality of client devices 200.

The central server 100 and the client device 200 are computing devices including a memory and a processor, and overall operations may be performed by instructions stored in the memory and calculations of the processor.

The central server 100 and the client device 200 may store artificial intelligence neural network models designed in the same structure to perform federated learning.

Hereinafter, in describing federated learning according to an embodiment of the present disclosure, a federated learning model stored in the central server 100 will be referred to as a “central learning model,” and a federated learning model stored in each of the plurality of client devices 200 will be referred to as a “local learning model.”

A general operation in which the central server 100 and the client device 200 configuring the federated learning system 10 train the federated learning model is as follows.

First, the central server 100 may transmit state information such as parameter values set in the central learning model to each client device 200.

Next, each client device 200 may train a local learning model using individual training data and transmit state information such as parameters of the trained local learning model to the central server 100.

Then, the central server 100 may collect state information of the local learning model trained by each client device 200 and update the state information of the central learning model.

As such, a series of processes in which the central server 100 transmits state information to the client device 200, collects newly trained state information, and then updates the model may be understood as a round of federated learning. The round of federated learning may proceed in multiple rounds according to the design, and after the final round is proceeded, finally updated state information of the central learning model and state information of each local learning model may be acquired.

In this connection, the central server 100 may transmit state information by selecting at least one client device 200 through sampling of some client devices 200 among the plurality of client devices 200 for each round of federated learning according to a predetermined method (for example, FedAvg, FedSGD, FedMA, etc.).

In this connection, the central server 100 may update the state information of the central learning model by reflecting the average value of the state information collected from at least one client device 200 according to a predetermined method (for example, FedAvg, FedSGD, FedMA, etc.).

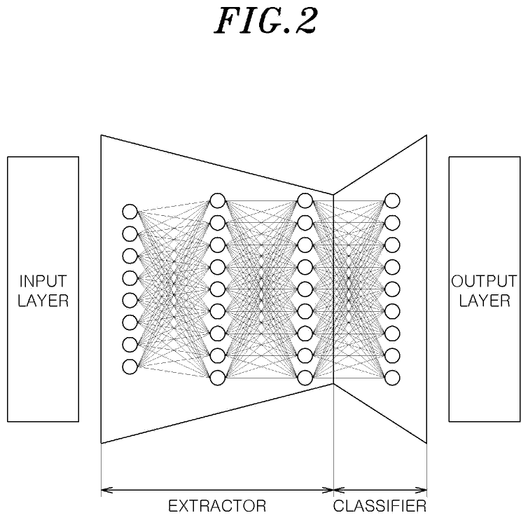

FIG. 2 is an exemplary diagram illustrating the structure of a central learning model and a local learning model used in the federated learning system 10 according to an embodiment of the present disclosure.

Referring to FIG. 2, a central learning model and a local learning model according to an embodiment may include a neural network configured of an input layer 21, a hidden layer 23, and an output layer 25. The federated learning system 10 according to an embodiment further divides the hidden layer 23 of the federated learning model into an extractor 23a and a classifier 23b.

Among the layers configuring the federated learning model, the extractor 23a may include a layer of a foremost end which is touched with the input layer 21 and a layer right up to a front end of a layer corresponding to a rearmost end of the hidden layer. For example, the extractor 23a may include a network layer including parameters for performing a convolution calculation by applying weights and biases to predetermined feature values or feature vectors.

The classifier 23b may include a layer of a rearmost end which is touched with the output layer among the layers configuring the federated learning model. For example, the classifier 23b may include a network layer including a parameter for distinguishing a decision boundary for distinguishing a class for the output layer 25.

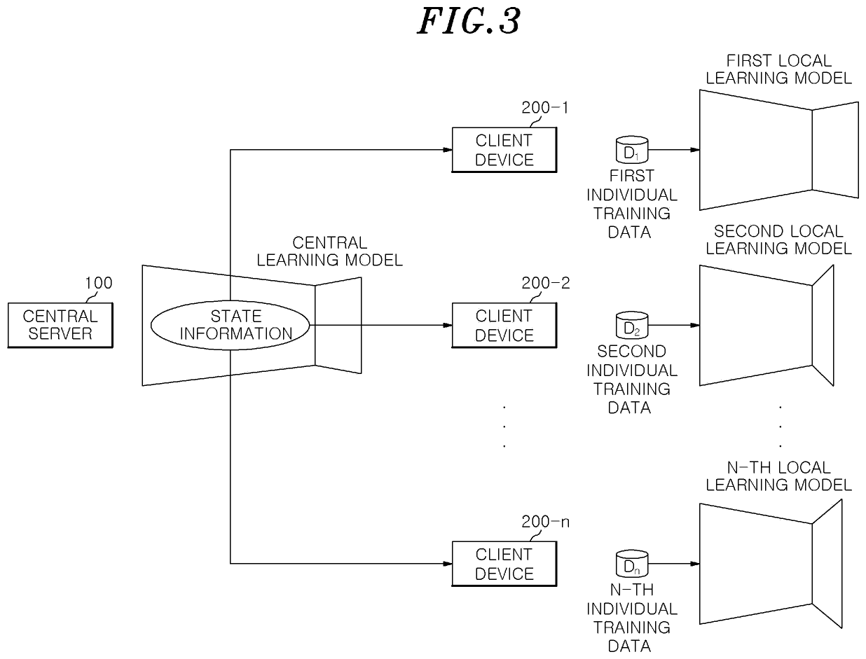

FIG. 3 is an exemplary diagram illustrating an operation in which the central server 100 transmits state information of the extractor in the central learning model to each client device and each client device 200 uploads the received state information to the extractor in the local learning model and then learns according to an embodiment of the present disclosure.

The central server 100 may transmit state information of the extractor in the central learning model to the plurality of client devices 200. In this connection, the central server 100 may transmit state information by selecting some client devices 200 among all client devices 200 for each round of federated learning according to a predetermined method (for example, FedAvg, FedSGD, FedMA, etc.). For example, the central server 100 may select at least one client device 200 through a sampling method.

Each of the client devices 200-1, 200-2, . . . , 200-n uploads the state information transmitted by the central server 100 to the extractor of the local learning model stored therein. Herein, the classifier in the local learning model of each of the client devices 200-1, 200-2, . . . , 200-n may be different from each other. In addition, each of the client devices 200-1, 200-2, . . . , 200-n may train the extractor and the classifier of the local learning model using a pre-agreed learning algorithm (for example, FedReNTD, etc.) using individually held data D₁, D₂, . . . , Dₙ.

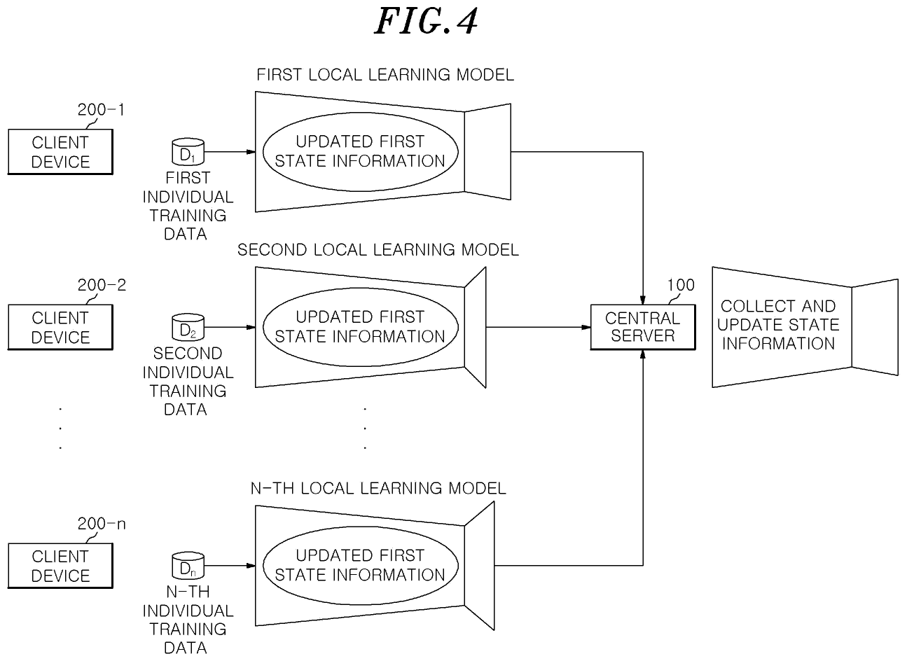

FIG. 4 is an exemplary diagram illustrating an operation in which each client device 200 transmits updated state information of the extractor in the local learning model to the central server 100, and the central server 100 collects the state information of the extractor in the updated local learning model of each client device 200 and updates the state information of the extractor in the central learning model according to an embodiment of the present disclosure.

Referring to FIG. 4, each client device 200 may transmit, to the central server 100, the updated state information of the extractor in the local learning model trained using individual training data D₁, D₂, . . . , Dₙ held by each thereof. In this connection, the central server 100 may update the state information of the extractor in the central learning model by combining the state information collected from the client device 200 according to a predetermined method (for example, FedAvg, FedSGD, FedMA, etc.), for example, taking an average value.

According to an embodiment of the present disclosure, the process of FIGS. 3 and 4 described above may be understood as one round of federated learning in which the central server 100 and the client device 200 participate together. In the federated learning rounds of FIGS. 3 and 4, a predetermined number of rounds may be performed according to a designer's selection.

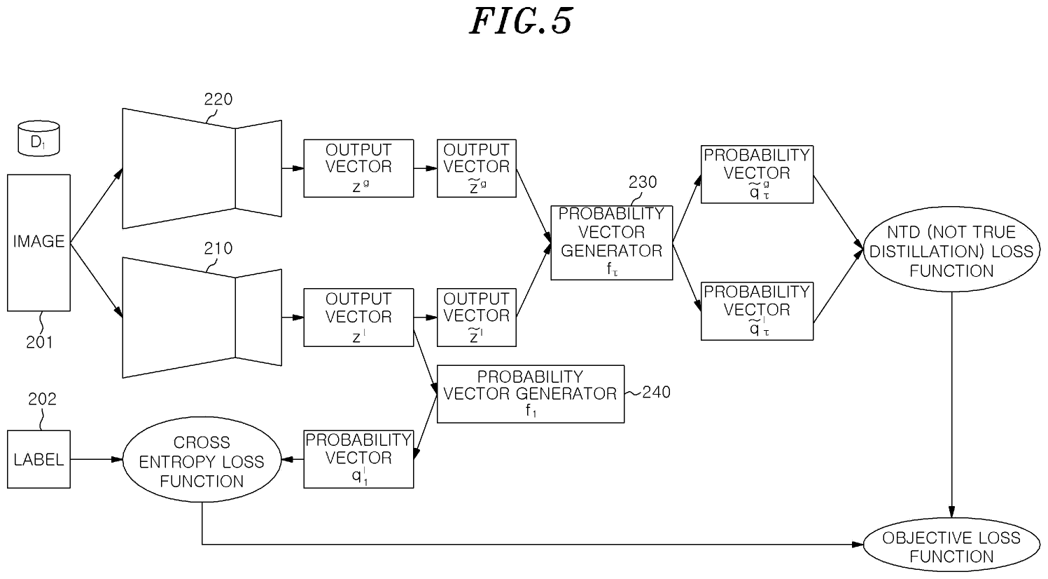

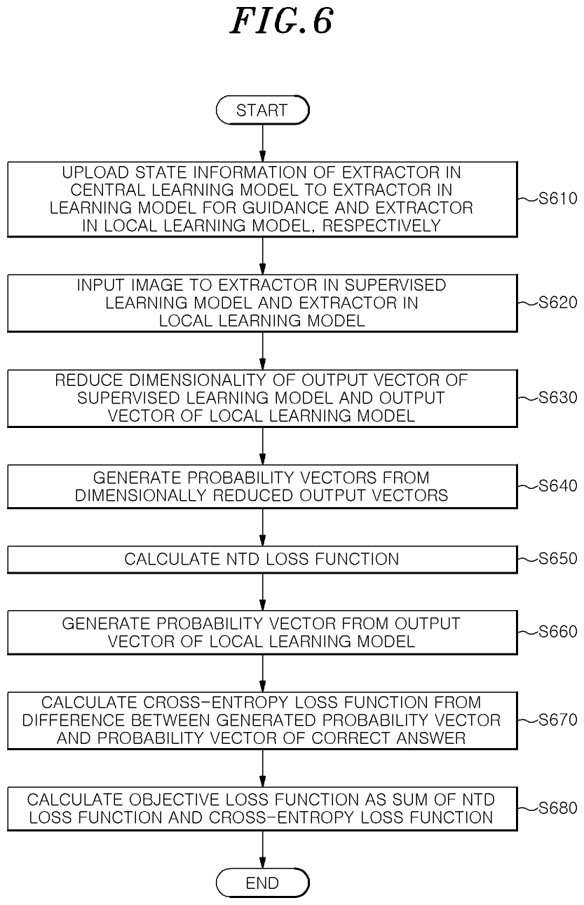

FIG. 5 is an exemplary diagram illustrating an operation in which each client device 200 trains the classifier and the extractor in the local learning model using a knowledge distillation technique according to an embodiment of the present disclosure. FIG. 6 is a flowchart illustrating a signal processing process in which each client device 200 performs a federated learning method according to an embodiment of the present disclosure.

The plurality of client devices 200 may include a local learning model 210 and a supervised learning model 220, and the local learning model 210 and the supervised learning model 220 may have the same structure.

Each client device 200 uploads the state information of the extractor in the central learning model received from the central server 100 to the extractor in the supervised learning model 220 and the extractor in the local learning model 210, respectively (S610).

Then, each client device 200 inputs the individual training data D₁, D₂, . . . , Dₙ held by each thereof to the extractor in the supervised learning model 220 and the extractor in the local learning model 210 (S620), and the supervised learning model 220 trains the extractor and classifier in the local learning model 210 in a fixed state using a knowledge distillation technique. Here, fixing the supervised learning model 220 may mean not updating state information such as parameters of an extractor and a classifier in the supervised learning model 220 while the local learning model 210 is learning. Here, the individual training data D₁, D₂, . . . , Dₙ held by each client device 200 may be configured of an image 201 and a label 202. Among the image 201 and the label 202, the image 201 may be input to the extractor in the supervised learning model 220 and the extractor in the local learning model 210, and the extractor and the classifier in the local learning model 210 may be trained with a goal of predicting the given label well for the input image.

Among the image 201 and the label 202 configuring the individual training data D₁, D₂, . . . , Dₙ the label 202 is a probability vector of a correct answer. Accordingly, each client device 200 needs to change the output vectors of the supervised learning model 220 and the local learning model 210 into probability vectors so as to be compared with the probability vector of the correct answer. In this regard, a probability vector generator may be used. The probability vector generator produces a different probability vector output depending on how the hyper-parameter τ in the generator is generated. In general, probability vector generators with τ=1 are often used, but knowledge distillation techniques use hyper-parameters that satisfy the property of τ>1. Accordingly, each client device 200 uses both a general probability vector generator and a probability vector generator to be used for knowledge distillation.

Upon reviewing the process of each client device 200 generating a probability vector from the output vector of the supervised learning model 220 and the output vector of the local learning model 210, the supervised learning model 220 outputs a C-dimensional output vector z^{g}, and the local learning model 210 outputs a C-dimensional output vector Then, each client device 200 removes the dimension designated as 1 from each output vector before generating a probability vector from each output vector, and further processes the same into a C-1-dimensional output vector z-^{g} and an output vector z⁻¹ (S630). Subsequently, the additionally processed C-1-dimensional output vector z-^{g} and output vector z-¹ are input to the probability vector generator 230 having the property of hyper-parameter τ>1, and generates a C-1-dimensional probability vector z˜^{g}_{τ} and a C-1-dimensional probability vector z˜¹_{τ} as an output of the corresponding probability vector generator 230 (S640). In addition, each client device 200 calculates a not true distillation (NTD) loss function from a difference between the C-1 dimensional probability vector z˜^{g}_{τ} and the C-1 dimensional probability vector (S650).

Each client device 200 learns in a direction of reducing the objective loss function calculated from the probability vector of the correct answer, which is the label 202 among the image 201 and the label 202 configuring the individual training data D₁, D₂, . . . , Dₙ, and the probability vector generated from the output vector of the supervised learning model 220 and the output vector of the local learning model 210. However, the cross-entropy loss function is further reflected in the objective loss function in addition to the NTD loss function.

Accordingly, each client device 200 inputs the C-dimensional output vector z¹ of the local learning model 210 to the C-dimensional random vector generator 240 having the property of the hyper-parameter τ=1, and generates a C-dimensional probability vector q¹₁ as an output of the corresponding probability vector generator 240 (S660). Then, a cross-entropy loss function is calculated from the difference between the generated C-dimensional probability vector q¹₁ and the probability vector of the correct answer (S670).

Then, each client device 200 calculates the objective loss function as the sum of the NTD loss function and the cross-entropy loss function (S680).

The series of learning processes described with reference to FIGS. 5 and 6 may be referred to as a learning part performed by the client device 200 in one round of federated learning performed by the central server 100 and the client device 200. After the central server 100 has updated the extractor in the central learning model as described with reference to FIG. 4, when transmitted from the central server 100 as described with reference to FIG. 3, the next round of federated learning proceeds after the updated state information is uploaded to the extractor in the supervised learning model 220 and the extractor in the local learning model 210 of each client device 200.

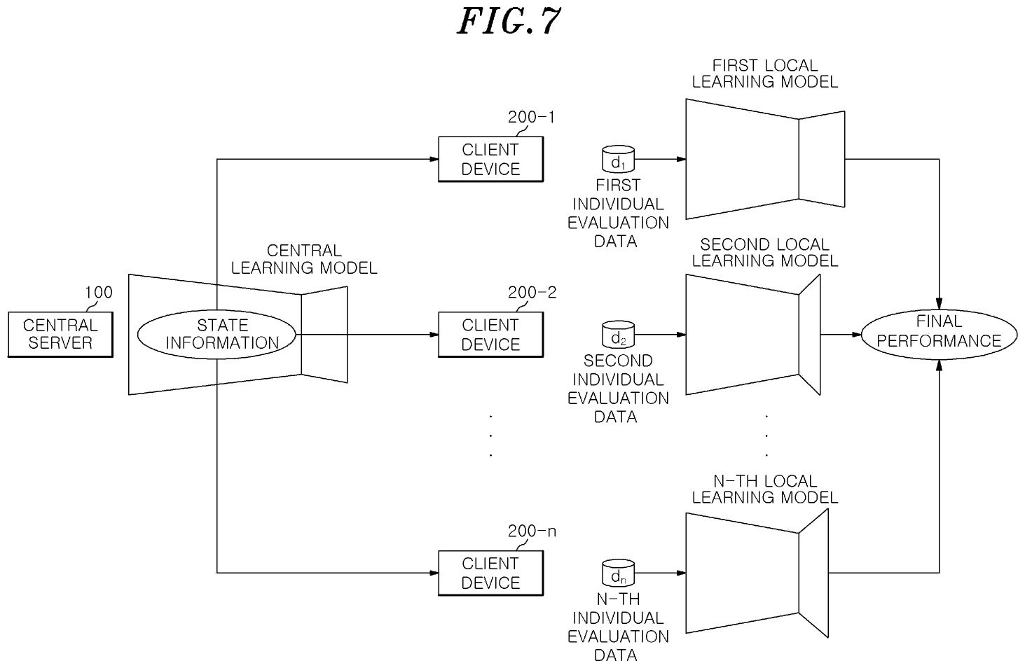

FIG. 7 is an exemplary diagram illustrating an evaluation process for a result of federated learning by the central server 100 and the client device 200 according to an embodiment of the present disclosure.

The central server 100 transmits the state information of the extractor in the central learning model to all client devices 200 participating in federated learning, and each client device 200 uploads the state information received from the central server 100 to the extractor in each local learning model 210. In addition, each client device 200 inputs the individual evaluation data d₁, d₂, . . . , dₙ to the local learning model 210, and then combines the prediction success rate by each client device 200, for example, takes an average value. Then, the final performance of federated learning by the central server 100 and the client device 200 may be evaluated.

A computer program may be implemented to include instructions for causing a processor to perform each phase included in the federated learning method of a client device and the federated learning method by a central server and a plurality of client devices according to the aforementioned embodiment.

In addition, a computer program may be implemented to include instructions for causing a processor to perform each phase included in the federated learning method of a client device and the federated learning method by a central server and a plurality of client devices according to the aforementioned embodiment may be recorded on a computer readable recording medium.

As described above, according to an embodiment of the present disclosure, state information of the extractor in the central learning model is transmitted to the client device, the client device uploads the received state information to the extractor in an individual learning model, and then the individual training data is used to perform learning with the extractor and the classifier. Through federated learning that transmits the state information updated through learning to the central server, improvement of the representation is promoted, and finally, the performance of federated learning is improved.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A federated learning system including:
a central server including a central learning model containing an extractor; and
a plurality of client devices each including a local learning model performing federated learning with the central learning model, wherein the local learning model includes an extractor and a classifier,
wherein the central server is configured to transmit state information of the extractor in the central learning model to at least one client device among the plurality of client devices, receive state information of the extractor in the local learning model from the at least one client device, and update the extractor in the central learning model using the received state information, and
wherein the at least one client device is configured to upload the state information to the extractor in the local learning model, train the extractor and the classifier in the local learning model using individual training data, and transmit state information of the extractor trained in the local learning model to the central server.

2. The federated learning system of claim 1, wherein the at least one client device is selected by the server among the plurality of client devices.

3. The federated learning system of claim 1, wherein the at least one client device further includes a supervised learning model having a structure same as that of the local learning model and containing an extractor and a classifier, and
wherein the at least one client device is configured to upload the state information to the extractor in the supervised learning model and the extractor in the local learning model, respectively, input the individual training data to the extractor in the supervised learning model and the extractor in the local learning model, and train the extractor and the classifier in the local learning model by a knowledge distillation technique while the supervised learning model is fixed.

4. The federated learning system of claim 3, wherein the individual training data includes an image data and a label data, and
wherein the at least one client device is configured to input the image to the extractor in the supervised learning model and the extractor in the local learning model, and train the extractor and the classifier in the local learning model to predict the label data from the input image data.

5. The federated learning system of claim 4, wherein the label data includes a probability vector of a correct answer, and
wherein the at least one client device is configured to generate the probability vector from an output vector of the supervised learning model and an output vector of the local learning model, and train the extractor and classifier in the local learning model to reduce an objective loss function calculated from the probability vector of the correct answer and the generated probability vector.

6. The federated learning system of claim 5, wherein the probability vector of the correct answer, the output vector of the supervised learning model, and the output vector of the local learning model are C-dimensional; and
wherein the at least one client device is configured to respectively process a C-dimensional output vector of the supervised learning model and a C-dimensional output vector of the local learning model respectively into a (C-1)-dimensional output vector of the supervised learning model and a (C-1)-dimensional output vector of the local learning model; generate a first (C-1)-dimensional probability vector and a second (C-1)-dimensional probability vector respectively from the respectively processed (C-1)-dimensional output vector of the supervised learning model and the processed (C-1)-dimensional output vector of the local learning model; generate a C-dimensional probability vector from the C-dimensional output vector of the local learning model; calculate a not true distillation (NTD) loss function from a difference between the first (C-1)-dimensional probability vector and the second (C-1)-dimensional probability vector; calculate a cross-entropy loss function from a difference between the generated C-dimensional probability vector and the probability vector of the correct answer; and calculate the objective loss function as a sum of the NTD loss function and the cross-entropy loss function.

7. A method for a client device including a local learning model to perform federated learning with a central server including a central learning model containing an extractor and other client devices including a local learning model containing an extractor and a classifier, the method including:
training the extractor and the classifier in the local learning model using individual training data after state information of the extractor in the central learning model is uploaded to the extractor in the local learning model; and
transmitting state information of the extractor trained in the local learning model to the central server so as to update state information of the extractor trained in the local learning model to the extractor in the central learning model.

8. The method of claim 7, wherein the client device includes a supervised learning model having a structure same as that of the local learning model and containing an extractor and a classifier; and
wherein the training the extractor and the classifier in the local learning model includes:
uploading the state information to the extractor in the supervised learning model and the extractor in the local learning model, respectively,
inputting the individual training data to the extractor in the supervised learning model and the extractor in the local learning model, and
training the extractor and the classifier in the local learning model using a knowledge distillation while the supervised learning model is fixed.

9. The method of claim 8, wherein the individual training data includes an image data and a label data, and
wherein the training the extractor and the classifier in the local learning model includes:
inputting the image data to the extractor in the supervised learning model and the extractor in the local learning model, and
training the extractor and the classifier in the local learning model to predict the label data from the input image data.

10. The method of claim 9, wherein the label data includes a probability vector of a correct answer, and
wherein the training the extractor and the classifier in the local learning model includes:
generating the probability vector from an output vector of the supervised learning model and an output vector of the local learning model, and
training the extractor and classifier in the local learning model to reduce an objective loss function calculated from the probability vector of the correct answer and the generated probability vector.

11. The method of claim 10, wherein the probability vector of the correct answer, the output vector of the supervised learning model, and the output vector of the local learning model are C-dimensional, and
wherein the training the extractor and the classifier in the local learning model includes:
processing a C-dimensional output vector of the supervised learning model and a C-dimensional output vector of the local learning model respectively into a (C-1)-dimensional output vector of the supervised learning model and a (C-1)-dimensional output vector of the local learning model;
generating a first (C-1)-dimensional probability vector and a second (C-1)-dimensional probability vector respectively from the processed (C-1)-dimensional output vector of the supervised learning model and the processed (C-1)-dimensional output vector of the local learning model;
generating a C-dimensional probability vector from the C-dimensional output vector of the local learning model;
calculating a not true distillation (NTD) loss function from a difference between the first (C-1)-dimensional probability vector and the second (C-1)-dimensional probability vector;
calculating a cross-entropy loss function from a difference between the generated C-dimensional probability vector and the probability vector of the correct answer; and
calculating the objective loss function as a sum of the NTD loss function and the cross-entropy loss function.

12. Anon-transitory computer-readable storage medium including computer executable instructions, wherein the instructions, when executed by a processor, cause the processor to perform a method for a client device including a local learning model containing an extractor and a classifier to perform federated learning with a central server including a central learning model containing an extractor, the method comprising:
training the extractor and the classifier in the local learning model using individual training data after state information of the extractor in the central learning model of the central server is uploaded to the extractor in the local learning model; and
transmitting state information of the extractor trained in the local learning model to the central server so as to update state information of the extractor trained in the local learning model to the extractor in the central learning model.

13. The computer-readable recording medium of claim 12, wherein the client device includes a supervised learning model having a structure same as that of the local learning model and containing an extractor and a classifier; and
wherein the training the extractor and the classifier in the local learning model includes:
uploading the state information to the extractor in the supervised learning model and the extractor in the local learning model, respectively,
inputting the individual training data to the extractor in the supervised learning model and the extractor in the local learning model, and
training the extractor and the classifier in the local learning model using a knowledge distillation while the supervised learning model is fixed.

14. The computer-readable recording medium of claim 13,
wherein the individual training data includes an image data and a label data, and
wherein the training the extractor and the classifier in the local learning model includes:
inputting the image to the extractor in the supervised learning model and the extractor in the local learning model, and
training the extractor and the classifier in the local learning model to predict the label data from the input image data.

15. The computer-readable recording medium of claim 14, wherein the label data includes a probability vector of a correct answer, and
wherein the training the extractor and the classifier in the local learning model includes:
generating the probability vector frog an output vector of the supervised learning model and an output vector of the local learning model, and
training the extractor and classifier in the local learning model to reduce an objective loss function calculated from the probability vector of the correct answer and the generated probability vector.

16. The computer-readable recording medium of claim 15, wherein the probability vector of the correct answer, the output vector of the supervised learning model, and the output vector of the local learning model are C-dimensional, and
wherein the training the extractor and the classifier in the local learning model includes:
processing a C-dimensional output vector of the supervised learning model and a C-dimensional output vector of the local learning model respectively into a (C-1)-dimensional output vector of the supervised learning model and a (C-1)-dimensional output vector of the local learning model;
generating a first (C-1)-dimensional probability vector and a second (C-1)-dimensional probability vector respectively from the processed (C-1)-dimensional output vector of the supervised learning model and the processed (C-1)-dimensional output vector of the local learning model;
generating a C-dimensional probability vector from the C-dimensional output vector of the local learning model;
calculating a not true distillation (NTD) loss function from a difference between the first (C-1)-dimensional probability vector and the second (C-1)-dimensional probability vector;
calculating a cross-entropy loss function from a difference between the generated C-dimensional probability vector and the probability vector of the correct answer; and
calculating the objective loss function as a sum of the NTD loss function and the cross-entropy loss function.
